(19) United States
(12) Patent Application Publication
(10) Pub. No.: US 2011/0153474 A1
(43) Pub. Date: Jun. 23, 2011

(54) ELECTRIC VEHICLE CHARGING AND ACCOUNTING

(76) Inventors: Milton T. Tormey, Los Altos, CA (US); Richard Lowenthal, Cupertino, CA (US); James Solomon, Saratoga, CA (US)

(21) Appl. No.: 12/641,284

(22) Filed: Dec. 17, 2009

(51) Int. Cl. G06Q 40/00; G06Q 30/00; G06Q 20/00; G06Q 10/00; G06Q 50/00; G06F 1/28; G06F 15/16

(52) U.S. Cl. 705/31; 705/34; 705/44; 705/412; 700/295; 709/204

(57) ABSTRACT

Electric vehicle charging stations include a time of use meter that can be programmed with different time periods so that different tariffs can be applied to energy readings of those different time periods. The time periods may be specific to electric vehicle operators. The tariffs may also be specific to electric vehicle operators and apply to charging stations that are supplied with electricity from different electric utilities.

### BACKGROUND

1. Field

Embodiments of the invention relate to the field of charging electric vehicles, and more specifically to electric vehicle charging and accounting.

2. Background

Electric vehicle charging stations (“charging stations”) are typically used to provide charging points for electric vehicles (e.g., electric battery powered vehicles, gasoline/electric battery powered vehicle hybrid, etc.). Charging stations may be located in designated charging locations (e.g., similar to locations of gas stations), parking spaces (e.g., public parking spaces and/or private parking space), etc. Most electric plug-in vehicles have on board chargers that accept either 110V, 220V (230V in Europe) and draw power at current levels from 10 A to 70 A.

Some charging stations include a meter to measure the amount of current that is being supplied by the charging station to the electric vehicle. The energy reading (measured in kWh and derived from the meter's current reading) is used during accounting when determining the cost of charging that vehicle. Typically, a single rate (or tariff; defined as cost per kWh) is applied to the total amount of energy transferred to an electric vehicle by a particular charging station. The single tariff is typically set by an electric utility that operated the power grid that supplies electricity to the charging station.

Charging stations can be geographically distributed and supplied with energy from different power grids that are operated by different electric utilities. Each different power grid or electric utility can have a different energy tariff (e.g., a different monetary amount per Kilowatt-hour (kWh)). In typical electric vehicle charging systems, electric vehicle operators are billed different monetary amounts for the same amount of energy supplied by different charging stations depending on the location of those charging stations.

### BRIEF DESCRIPTION OF THE DRAWINGS

The invention may best be understood by referring to the following description and accompanying drawings that are used to illustrate embodiments of the invention. In the drawings:

FIG. 1 illustrates an exemplary charging system according to one embodiment of the invention;

FIG. 2 illustrates an exemplary embodiment of the charging station illustrated in FIG. 1 according to one embodiment of the invention;

FIG. 3 illustrates an exemplary charging station network according to one embodiment of the invention;

FIG. 4 is a flow diagram illustrating exemplary operations for a charging session with a charging station that has a time of use meter according to one embodiment of the invention; and

FIG. 5 is a flow diagram illustrating exemplary operations for a charging session with a charging station that does not have a time of use meter according to one embodiment of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

The techniques shown in the figures can be implemented using code and data stored and executed on one or more computing devices (e.g., electric vehicle charging stations, electric vehicle charging station network servers, etc.). As used herein, a charging station is a piece of equipment, including hardware and software, to charge electric vehicles. Such computing devices store and communicate (internally and with other computing devices over a network) code and data using machine-readable media, such as machine storage media (e.g., magnetic disks; optical disks; random access memory; read only memory; flash memory devices; phase-change memory) and machine communication media (e.g., electrical, optical, acoustical or other form of propagated signals—such as carrier waves, infrared signals, digital signals, etc.). In addition, such computing devices typically include a set of one or more processors coupled to one or more other components, such as a storage device, one or more input/output devices (e.g., a keyboard, a touchscreen, and/or a display), and a network connection. The coupling of the set of processors and other components is typically through one or more busses and bridges (also termed as bus controllers). The storage device and signals carrying the network traffic respectively represent one or more machine storage media and machine communication media. Thus, the storage device of a given computing device typically stores code and/or data for execution on the set of one or more processors of that device. Of course, one or more parts of an embodiment of the invention may be implemented using different combinations of software, firmware, and/or hardware.

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements.

In some embodiments, the tariff for electricity supply is specific to individual vehicle operators and those tariffs apply to charging stations that supply energy from different power grids that are operated by different electric utilities (electric vehicle operator dependent tariff). For example, an electrical vehicle operator can negotiate a tariff with an electric utility (e.g., that operator's local electric utility or some different electric utility) and that tariff can be used when charging their electric vehicle(s) regardless of the location of the charging station and which electric utility controls the electricity supply for that charging station.

In some embodiments, the charging stations include a time of use meter in order to record energy readings for different time periods of the day. Each time period is typically associated with a different tariff for the electricity transferred. Examples of time periods that may be used include peak hours, non-peak hours, overnight hours, daytime hours, or any other time period. While in some embodiments the electric vehicle operators have a different electric vehicle operator dependent tariff for each different time period, in other embodiments the tariffs are specific to the electric utilities that control the electricity supply of the charging stations. In other embodiments the electric vehicle operators have different electric vehicle operator dependent tariffs, which may include different tariffs for different time periods, for different electric utilities.

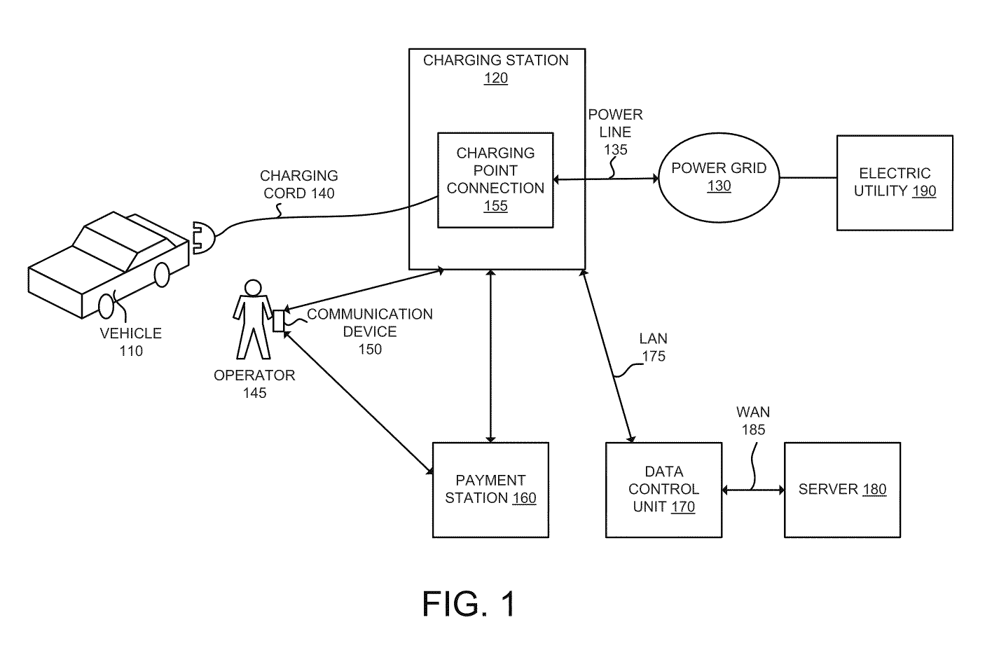

FIG. 1 illustrates an exemplary charging system according to one embodiment of the invention. The charging system illustrated in FIG. 1 includes the charging station 120, which is coupled with the power grid 130 over the power line 135. In some embodiments the power grid 130 is owned and/or operated by the electric utility 190. It should be understood that the power grid 130 and the electric utility 190 may be owned or operated by different entities. In addition, it should be understood that the power grid 130 may be used by multiple electric utilities. The electric utility 190 is typically a public entity that locally operates the power grid 130, however the electric utility 190 may be a private company or person.

Operators of electric vehicles (e.g., the electric vehicle operator 145) use the charging station 120 to charge their electric vehicles (e.g., the electric vehicle 110). For example, the electricity storage devices (e.g., batteries, supercapacitors, etc.) of electric vehicles (e.g., electric powered vehicles, gasoline/electric powered vehicle hybrids, etc.) may be charged through use of the charging station 120. It should be understood that electric vehicle operators may include drivers of electric vehicles, passengers of electric vehicles, and/or service personnel of electric vehicles. In one embodiment, the operators of electric vehicles provide their own charging cord to charge their electric vehicle (e.g., the electric vehicle operator 145 plugs in the charging cord 140 into the charging point connection 155 of the charging station 120), while in other embodiments the charging point connection 155 of the charging station 120 includes circuitry for an attached charging cord (e.g., the charging cord 140 is fixably attached to the charging point connection 155 of the charging station 120).

In one embodiment, the charging station 120 can charge in a dual mode at different voltages (e.g., 120V and 240V). By way of example, a fixably attached charging cord is typically used in a higher voltage mode (e.g., 240V) and an unattached charging cord is typically inserted into a power receptacle of the charging station 120 in a lower voltage mode (e.g., 120V).

In some embodiments, the flow of electrical power can be in either direction on the power line 135. In other words, the electric vehicle 110 can be charged from the power grid 130 or the power grid 130 can receive power from the electric vehicle 110 (hereinafter referred to as “vehicle-to-grid” (V2G)). Thus, in some embodiments of the invention, the electric vehicle 110 may consume electricity from the power grid 130 as well as transfer electricity to the power grid 130.

The charging station 120 is also coupled with the server 180 through the data control unit (DCU) 170. The DCU 170 acts as a gateway to the server 180 and relays messages and data between the charging station 120 and the server 180. The charging station 120 exchanges messages and data with the DCU 170 over the LAN (Local Area Network) link 175 (e.g., WPAN (Wireless Personal Area Network) (e.g., Bluetooth, ZigBee, etc.), or other LAN links (e.g., Ethernet, PLC (Power Line Communication), WiFi, etc.)). The DCU 170 exchanges messages and data with the server 180 over the WAN link 185 (e.g., Cellular (e.g., CDMA, GPRS, etc.) WiFi Internet connection, Plain Old Telephone Service, leased line, etc.). According to one embodiment of the invention, the DCU 170 can be included as part of a charging station (e.g., the charging station 120 or a different charging station coupled with the server 180). In other embodiments the DCU 170 is a separate device not part of a charging station. In some embodiments, the charging station 120 is coupled with the server 180 directly (i.e., without a connection through a DCU).

The server 180 provides services for multiple charging stations including authorization services, accounting services, usage monitoring, real-time control of the charging stations, etc. As will be described in greater detail later herein, in some embodiments the server 180 provides time of use definitions (e.g., time of use periods) and/or tariffs for multiple charging stations that are supplied electricity from multiple electric utilities. In addition, in some embodiments the server 180 provides services for multiple charging stations that are connected to power grids operated by different electric utilities than the electric utility 190.

In one embodiment, the server 180 stores vehicle operator information (e.g., operator account information, operator contact information (e.g., operator name, street address, email address, telephone number, etc.), time of use periods, tariff(s) to apply to charging sessions, etc.) and charging station configuration information. The charging station configuration information can include information related to each charging station and the charging sessions on the charging stations. For example, for each charging station, the server 180 can store the following: the wiring group the charging station belongs to (as used herein, a wiring group corresponds to the physical wiring connection to a common circuit breaker), the electrical circuit capacity of the wiring group (e.g., the breaker size), a trip margin used to prevent false circuit breaker trips, a quantity of electric current that is currently being consumed or transferred, whether a vehicle is plugged into the charging station, the length of charging sessions (current and past), the tariff(s) to apply to that charging session, the different time periods of that charging station, whether the charging station has a time of use meter, etc.

In one embodiment of the invention, the server 180 includes a subscriber portal, available through the Internet, which allows subscribers (owners and operators of electric vehicles) to register for service (which may include providing information regarding their electric vehicles, providing payment information, providing contact information, etc.) and perform other functions (e.g., pay for charging sessions, determine availability of charging stations, check the charging status of their electric vehicle(s), etc.). The subscriber portal may also allow the electric vehicle operators to negotiate or establish a tariff specific to an operator (an operator dependent tariff) for charging their electric vehicles (which may or may not be the tariff at which that operator is billed for power at his home or business). As will be described in greater detail later herein, an electric vehicle charging tariff specific to an operator can be applicable regardless of the location of the charging station and regardless of the electric utility that controls the electricity supply for that charging station.

In one embodiment, the subscriber portal also allows the vehicle operators to set and/or modify a language preference for use on the charging stations (e.g., the language displayed on the charging stations). By way of example, after setting the language preference, the selected language will be displayed after authenticating a vehicle operator. In one embodiment, the language preference is written to the mobile communication device 150 (e.g., if the mobile communication device 150 is a smartcard) and read during charging session requests. In other embodiments the language preference of the vehicle operators is stored in the server 180 and provided to the charging station during or after authorizing the vehicle operator. In some embodiments the electric vehicle operators can also set and/or modify their language preference at the charging stations.

In addition, the server 180 may include a host portal, available through the Internet, which allows owners or administrators of the charging station 120 (and other charging stations) to configure their charging stations and perform other functions (e.g., determine average usage of charging stations, etc.). Charging stations may also be configured using other means in some embodiments of the invention (e.g., through Telnet, user interface, etc.). The host portal may also allow the owners or administrators to set tariffs(s) and/or different time periods for time of use charging.

The charging station 120 controls the application of electricity between the charging point connection 155 and the power grid 130 by energizing and de-energizing the charging point connection 155. In one embodiment, the server 180 instructs the charging station 120 to energize the charging point connection 155 and can also instruct the charging station 120 to de-energize the charging point connection 155. In one embodiment, the charging point connection 155 is a power receptacle or circuitry for an attached charging cord (e.g., thus the charging station 120 can energize/de-energize the power receptacle or the circuitry for an attached charging cord). The power receptacle can be any number of types of receptacles such as receptacles conforming to the NEMA (National Electrical Manufacturers Association) standards 5-15, 5-20, and 14-50 or other standards (e.g., BS 1363, CEE7, etc.) and may be operating at different voltages (e.g., 120V, 240V, 230V, etc.).

Electric vehicle operators can request charging sessions for their electric vehicles in different ways in different embodiments of the invention. As one example, the electric vehicle operator 145 can use the communication device 150 to initiate and request a charging session for the electric vehicle 110. The communication device 150 may be a WLAN or WPAN device (e.g., one or two-way radio-frequency identification (RFID) device, mobile computing device (e.g., laptops, palmtop, smartphone, multimedia mobile phone, cellular phone, etc.), ZigBee device, etc). The communication device 150 communicates unique operator-specific information (e.g., operator identification information, etc.) to the charging station 120, either directly or indirectly through the server 180. In some embodiments, electric vehicle operator 145 may use the communication device 150 to monitor the charging status of the electric vehicle 110. In one embodiment of the invention, the communication device 150 may be coupled with the electric vehicle 110 or part of the electric vehicle 110. In some embodiments, the electric vehicle operator 145 may use the communication device 150 to communicate operator dependent tariff (s) and/or operator dependent time periods for time of use charging to the charging station 120.

In other embodiments, the electric vehicle operator 145 uses the communication device 150 to communicate charging preferences to the charging station 120 which may indicate when charging should start and/or at what tariff. For example, the preferences may indicate that the charging station 120 should not charge the electric vehicle while daytime tariffs apply unless the battery has less than a certain amount of range left (e.g., in miles).

As another example of requesting a charging session, the electric vehicle operator 145 may interact with the payment station 160 coupled with the charging station 120, which may then send appropriate instructions to the charging station 120 regarding the charging of the vehicle 110 (e.g., instructions to energize the charging point connection 155). The payment station 160 can be configured to receive charging session requests and payments through the communication device 150 and/or through a user interface (e.g., a display and input buttons). The payment station 160 may include a credit card reader for on-demand payment. The payment station 160 is coupled with the charging station 120 through a LAN link. The payment station 160 may function similarly to a payment station for a parking space. In addition, the payment station 160 may be used both for parking payment and charging payment.

As yet another example, the electric vehicle operator 145 may use a user interface of the charging station 120 to request a charging session for the electric vehicle 110. As another example, the electric vehicle operator 145 can use a combination of the communication device 150 and the payment station 160 or the combination of the communication device 150 and the charging station 120 to request and/or pay for charging sessions.

In some embodiments, the electric vehicle operators can request charging sessions with a set of one or more parameters. For example, the electric vehicle operator 145 may request to charge the electric vehicle 110 until a limit is reached. The limit can include a monetary amount of electricity (e.g., charge ten dollars worth of electricity), a credit amount (e.g., charge ten credits worth of electricity), an amount of time (e.g., charge for three hours), etc. The electric vehicle operator 145 can also indicate a priority for the charging session. In some embodiments a higher priority charging session can cost more than a lower priority charging session.

Different charging plans with different billing models can be used in different embodiments. For example, a pay-as-you-go model can be used where electric vehicle operators can pay for the charging session at the time of the charging session. The operators may use the payment station 160 to pay for the charging session or pay for the charging session directly through the charging station 120. As another example, a bill-later model can be used where electric vehicle operators have an account with a charging service and are billed for their use at some interval (e.g., daily, weekly, monthly, quarterly, etc.). As another example, a prepaid subscription model can be used where electric vehicle operators have an account with a charging service and pay for the service in advance (the amounts can be deducted after each charging session is complete). As another example, a prepaid card model can be used where a card (e.g., the mobile communication device 150) includes a certain amount of charging credits (e.g., amount of time, amount of electricity, etc.). In a prepaid card model, the credits can be worth different values depending on the time they are used and/or priority of the charging session. For example, a single credit can be worth more during non-peak hours than peak hours (e.g., during non-peak hours, a single credit can be equivalent to one minute worth of charging while in peak hours that credit can be equivalent to thirty seconds worth of charging).

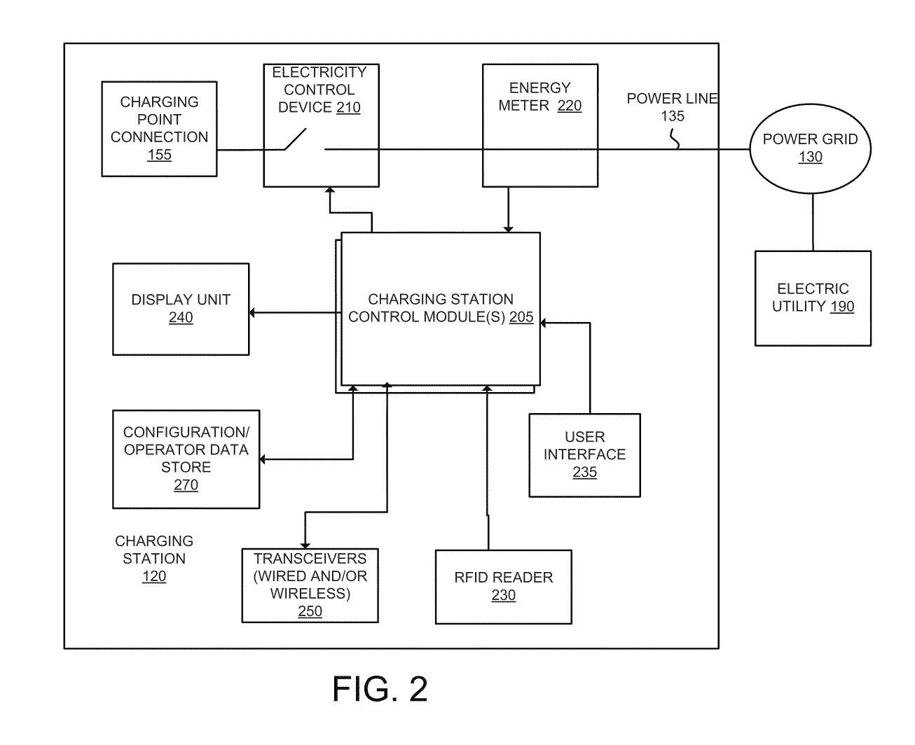

FIG. 2 illustrates an exemplary embodiment of the charging station 120 according to one embodiment of the invention. The charging station 120 includes the charging point connection 155, one or more charging station control modules 205, the electricity control device 210, the energy meter 220, the RFID reader 230, the user interface 235, the display unit 240, and one or more transceivers 250 (e.g., wired transceiver(s) (e.g., Ethernet, power line communication (PLC), etc.) and/or wireless transceiver(s) (e.g., 802.15.4 (e.g., ZigBee, etc.), Bluetooth, WiFi, Infrared, GPRS/GSM, CDMA, etc.)). It should be understood that FIG. 2 illustrates an exemplary architecture of a charging station, and other, different architectures may be used in embodiments of the invention described herein. For example, some implementations of charging stations may not include a user interface, an RFID reader, or a connection to a network.

The RFID reader 230 reads RFID tags from RFID enabled devices (e.g., smartcards, key fobs, etc., embedded with RFID tag(s)) of operators that want to use the charging station 120. For example, the operator 145 may wave/swipe the mobile communication device 150 (if an RFID enabled device) near the RFID reader 230 to request a charging session from the charging station 120.

The RFID reader 230 passes the information read to the charging station control modules 205. The charging station control modules 205 are programmed to include instructions that establish charging sessions with the vehicles. In one embodiment, the operator 145 is authenticated and authorized based on the information the RFID reader 230 receives. While in one embodiment of the invention the charging station 120 locally stores authorization information (e.g., in the configuration/operator data store 270), in other embodiments of the invention the charging station control modules 205 transmits an authorization request with a remote device (e.g., the server 180) via one of the transceivers 250. For example, the charging station control modules 205 cause an authorization request to be transmitted to the data control unit 170 over a WPAN transceiver (e.g., Bluetooth, ZigBee) or a LAN transceiver. The data control unit 170 relays the authorization request to the server 180.

In some embodiments, in addition to or in lieu of vehicle operators initiating charging sessions with RFID enabled devices, vehicle operators may use the user interface 235 to initiate charging sessions. For example, vehicle operators may enter in account and/or payment information through the user interface 235. For example, the user interface 235 may allow the operator 145 to enter in a username/password (or other information) and/or payment information. In some embodiments, the vehicle operators can also define a privilege or priority level of their request (e.g., charge immediately, charge anytime, etc.) which may affect the cost of the electricity supplied during the charging session.

The charging station control modules 205 cause the charging point connection 155 to be energized or de-energized. For example, the charging station control modules 205 cause the electricity control device 210 to be energized by completing the connection of the power line 135 to the power grid 130. In one embodiment, the electricity control device 210 is a solid-state device that is controlled by the charging station control modules 205 or any other device suitable for controlling the flow of electricity. In some embodiments, the charging station control modules 205 cause the charging point connection 155 to be energized or de-energized based on messages received from the server 180 or from the payment station 160.

The energy meter 220 measures the amount of energy flowing on the power line 135 through the charging point connection 155 (e.g., between the vehicle 110 and the charging station 120). In some embodiments, the energy meter 220 can measure the energy flowing to electric vehicles and the energy flowing from the electric vehicles to the power grid 130 (e.g., in a V2G case). The energy meter 220 may include or be coupled with an induction coil or other devices suitable for measuring current. The energy meter 220 is coupled with the charging station control modules 205. The charging station control modules 205 are programmed with instructions to monitor the output from the energy meter and calculate energy readings (e.g., the amount of electricity being used over a given time period, typically in Kilowatt-hours (kWh)). In some embodiments the energy meter 220 is a time of use meter that can be programmed with different time periods so that different energy readings can be made for the different time periods.

The display unit 240 is used to display messages to the operator 145 (e.g., charging status, confirmation messages, error messages, notification messages, etc.). The display unit 240 may also display parking information if the charging station 120 is also acting as a parking meter (e.g., amount of time remaining in minutes, parking violation, etc.). The configuration/operator data store 270 stores configuration information which may be set by administrators, owners, or manufacturers of the charging station 120.

While FIG. 1 illustrates a single charging station 120, it should be understood that many charging stations may be networked to the server 180 (through one or more data control units) and/or to each other. In addition, the server 180 can be coupled with multiple charging stations that are supplied with energy from different power grids operated or controlled by different electric utilities.

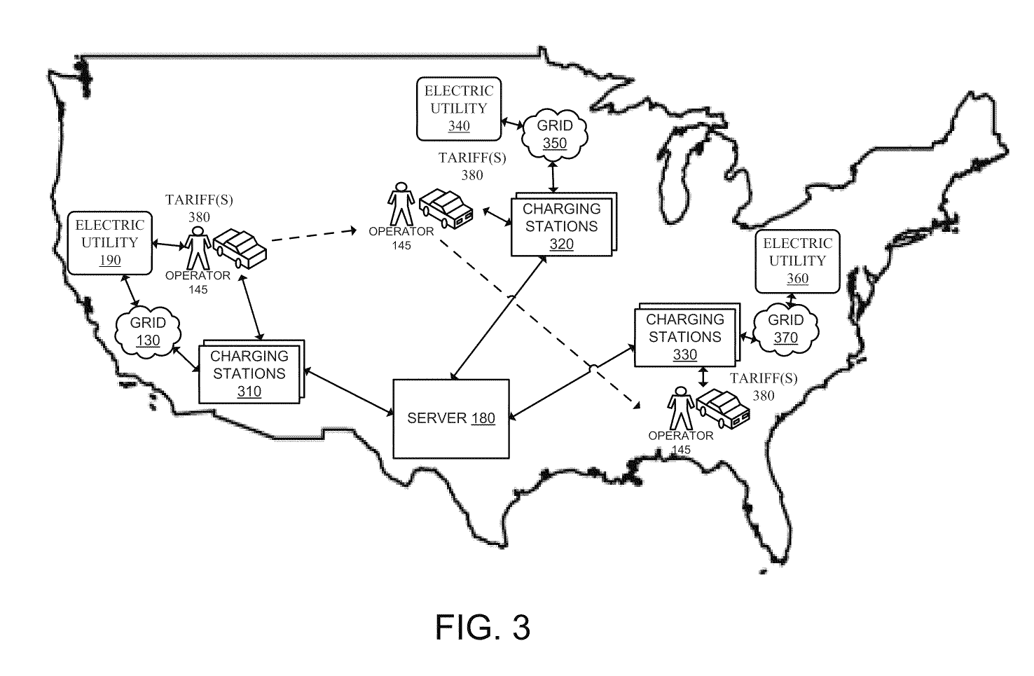

FIG. 3 illustrates an exemplary charging station network according to one embodiment of the invention. As illustrated in FIG. 3, different electric utilities in different geographic regions operate and/or control different power grids that supply electricity to charging stations. For example, the electric utility 190 controls and/or operates the power grid 130, which supplies electricity to the group of charging stations 310 (the charging station 120 is part of the charging stations 310). The electric utility 340 controls and/or operates the power grid 350, which supplies electricity to the group of charging stations 320. The electric utility 360 controls and/or operates the power grid 370, which supplies electricity to the group of charging stations 330. By way of example, the electric utilities 190, 340, and 360 are different companies/organizations and charge a different tariff for electricity consumption. Although not illustrated in FIG. 3, it should be understood that some of the charging stations in the charging station groups 310, 320, and 330 can include time of use meters. It should be understood that multiple electric utilities may share and use the same grid and may apply different tariffs.

FIG. 3 also illustrates the electric vehicle operator 145 using different charging stations that are supplied with electricity from different power grids that are operated and/or controlled by different electric utilities. As illustrated in FIG. 3, the electric vehicle operator 145 has one or more operator dependent tariffs 380, which are associated with the electric utility 190. The operator dependent tariff(s) 380 can include one or more of the following: time of use tariffs (a different tariff for each time period to be used for time of use metering), a priority tariff (a tariff for high priority charging sessions (which can include a surcharge)), a non-time of use charging station tariff (a tariff used when a charging station does not have a time of use meter), roaming tariff(s) (tariff(s) used when the electric vehicle operator is using a charging station of a different electric vehicle charging service (which can also include a surcharge)), etc. By way of example, the tariff(s) 380 are negotiated with the electric utility 190, which may be the local utility of the electric vehicle operator 145. The tariff(s) 380 may also be used for time of use metering as will be described later herein (e.g., different tariffs may apply to different time periods). In one embodiment, the server 180, which is coupled with the charging station groups 310, 320, and 330, causes the tariffs(s) 380 to be applied for the charging sessions on those charging stations.

For purposes of FIG. 3, the tariff(s) 380 are electric vehicle operator dependent tariff(s) that will apply to charging sessions of the electric vehicle operator 145 regardless of which charging station in the charging station groups 310, 320, and 330 is used to charge the electric vehicle. Thus, the electric vehicle operator 145 is billed using the same tariff(s) regardless of which electric utility is supplying the electricity to the charging stations. Thus, the operator 145 will be billed using the tariff(s) 380 when using the charging stations 310, 320, or 330, even though they are supplied electricity by the electric utilities 190, 340, and 360 respectively.

As described above, the electric utilities 190, 340, and 360 may generally apply different tariffs, however, the electric vehicle operator 145 will be billed using the tariff(s) 380 regardless if it differs from the tariff(s) of those electric utilities. In one embodiment, the difference between the amount billed to the electric vehicle operators by the electric vehicle charging service and the amount billed by the electric utilities to the electric vehicle charging service is settled by the electric vehicle charging service (e.g., the charging service may keep the difference if the amount billed is less than the amount billed to the electric vehicle operator and may pay the difference if the amount billed is more than the amount billed to the electric vehicle operator).

While FIG. 3 illustrates the tariff(s) being associated with a particular electric utility (e.g., the electric utility 190), embodiments of the invention are not so limited. For example, tariff(s) can be assigned by the electric vehicle charging service (e.g., during registration of the electric vehicle operator) and may not be associated with any electric utility.

While FIG. 3 illustrates embodiments of the inventions in relation to vehicle operator dependent tariff(s) that are specific to a single vehicle operator, in some embodiments the tariff(s) are specific to groups of vehicle operators (e.g., employees of a company, members of a travel group, or other groups). By way of example, a company may negotiate corporate tariff(s) for employees and these tariff(s) can be used regardless of the location of the charging stations and the electric utilities providing electricity service to those charging stations.

While FIG. 3 illustrates the continental United States, it should be understood that electric utilities and charging stations can be located in different countries. In some embodiments the vehicle operator dependent tariffs apply in different countries.

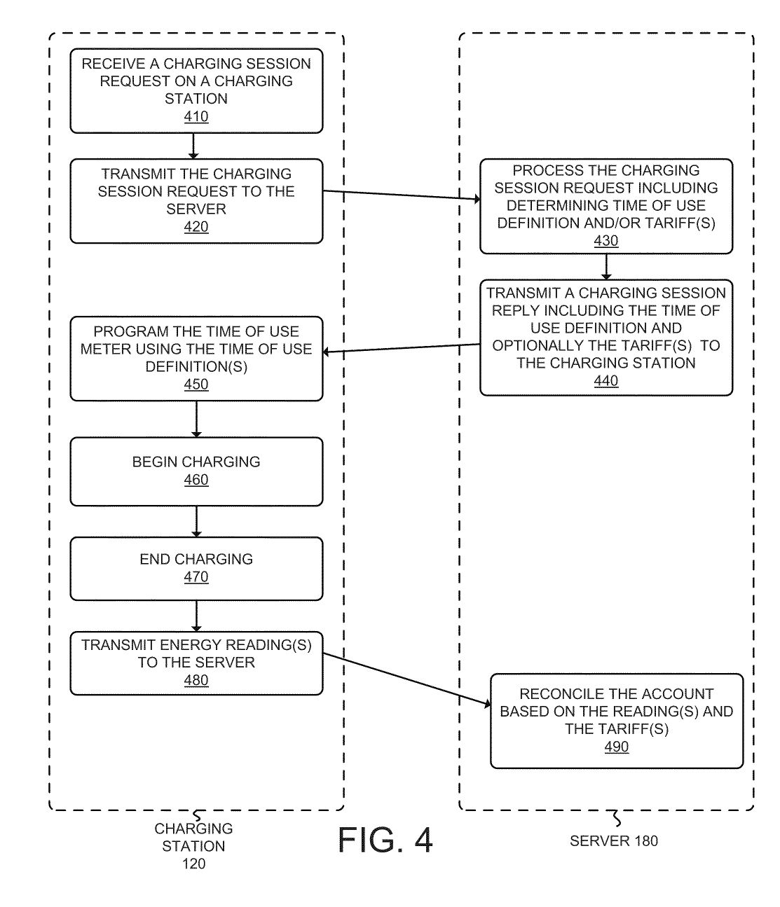

As previously described, some charging stations may include a time of use meter. For example, in some embodiments the energy meter 220 is a time of use meter that can be programmed with different time periods so that different energy readings can be taken for the different time periods. FIG. 4 is a flow diagram illustrating exemplary operations for a charging session on a charging station that has a time of use meter according to one embodiment of the invention. FIG. 4 will be described with the exemplary embodiment of FIG. 2, however it should be understood that the operations of FIG. 4 can be performed by embodiments of the invention other than those discussed with reference to FIG. 2, and the embodiments discussed with reference to FIG. 2 can perform operations different than those discussed with reference to FIG. 4. FIG. 4 will be described with reference to the charging station 120 and the server 180, however it should be understood that other charging stations (e.g., charging stations in the charging station groups 310, 320, and 330) can perform similar operations.

At block 410, a charging session request is received at the charging station 120 from the electric vehicle operator 145. As described above, the charging session request may be received via the communication device 150, the payment station 160, and/or directly through the user interface 235. The charging session request identifies the electric vehicle operator 145 (e.g., the request includes an identifier associated with the electric vehicle operator 145). The request may also include a set of one or more parameters (e.g., a charging session duration limit (e.g., a monetary amount, a credit amount, an amount of time), a priority level, etc.). Control flows to block 420 where the charging station 120 transmits the charging session request to the server 180.

At block 430, the server 180 processes the charging session request including determining the time of use definition (which identifies one or more time periods) and the corresponding tariffs(s) to apply for the charging session. While in one embodiment the time of use definition and/or the tariff(s) are specific to the electric vehicle operator 145, in other embodiments the time of use definition and/or the tariff(s) are specific to different groups of vehicle operators (e.g., employees of a company, members of a travel group, etc.) or specific to the charging station 120, the electric utility 190, or the power grid 130. Time of use definitions and/or the tariffs specific to electric vehicle operators may supersede the time of use definitions and/or tariffs specific to the charging stations or electric utilities. It should be understood that if the tariff(s) are electric vehicle operator dependent tariff(s), those tariff(s) are used regardless of which charging station (and which electric utility is responsible for generating the electricity for the charging station) the request is received from. Thus, electric vehicle operator dependent tariff(s) are applicable to different charging stations associated with different electric utilities. The tariff(s) can also depend on the time the request was received. For example, different tariffs can apply based on different time periods (e.g., peak hours, non-peak hours, overnight hours, daytime hours, etc.). These different tariffs can also be specific to the electric vehicle operator 145 or specific to the charging station 120 or the electric utility 190.

In one embodiment a combination of time period(s) and tariff(s) can be used. For example, the time of use definition can be specific to the charging station 120 or the electric utility 190, while the tariff(s) can be specific to the electric vehicle operator 145.

The server 180 also performs an authorization procedure to determine whether the electric vehicle operator is authorized to use the charging station 120 at the time of the request. In one embodiment, the server 180 does not determine the time of use definition or tariff(s) if the electric vehicle operator is not authorized.

In some embodiments the time periods for the time of use meter are specific to the electric utilities and are programmed into the time of use meter prior to receiving requests from electric vehicle operators. In such embodiments, the server 180 does not determine the time of use definition.

Flow moves from block 430 to block 440, where the server 180 transmits a charging session reply including the time of use definition and optionally the tariff(s) to the charging station 120. According to one embodiment, the tariff(s) will be transmitted to the charging station 120 upon receipt of a request that includes a monetary amount limit or a credit amount limit, and the charging station 120 uses those tariff(s) to calculate the cost of the electricity being consumed in order to determine when the limit is reached. Flow moves from block 440 to block 450.

At block 450, the charging station 120 programs its time of use meter using the time of use definition received from the server 180. For example, the different time period(s) indicated in the time of use definition are programmed into the time of use meter 220 of the charging station 120.

Flow moves from block 450 to block 460, where a charging session has been established and charging is allowed to commence. In one embodiment, establishing the charging session includes allowing current to flow between the electric vehicle and the charging station 120. For example, the charging station control modules 205 cause the electricity control device 210 to energize the charging point connection 155. During the charging session, the charging station 120 measures the amount of current being consumed for the different time period(s) and calculates the energy readings (e.g., kWh readings) for those different time period(s). In some embodiments, the charging station 120 also calculates the cost of the electricity being consumed based on the energy reading(s) and the corresponding tariff(s) received from the server 180.

Flow moves from block 460 to block 470 where the charging session has stopped. For example, the electric vehicle operator has terminated the charging session, the requested limit has been reached, etc. For example, if the request included a limit based on a monetary amount of electricity (e.g., ten dollars worth of electricity), the charging station 120 ceases charging once that amount of electricity has been consumed. In some embodiments, a notification message (e.g., email, text message, etc.) is transmitted to the vehicle operator 145 that alerts the operator that the charging session has ended because a charging session duration limit (e.g., monetary, credit, etc.) has been met. The notification message may be transmitted by the charging station 120 or the server 180. With reference to FIG. 2, the charging station control modules 205 cause the electricity control device 210 to de-energize the charging point connection 155 to prevent electricity from being transferred between the electric vehicle and the charging station 120.

Flow moves from block 470 to block 480, where the charging station 120 transmits the energy reading(s) to the server 180. There may be multiple energy readings depending on whether charging occurred during multiple time of use periods. The energy reading(s) can be sent along with a charging session termination message that notifies the server 180 that the charging session has ended. Of course, it should be understood that the charging station 120 can transmit energy readings to the server 180 while the charging session is in progress.

Flow moves from block 480 to block 490, where the server 180 reconciles the account of the electric vehicle operator based on the reading(s) and the corresponding tariff(s). For example, the server 180 bills the electric vehicle operator (or deducts from an account or prepaid card or plan of the electric vehicle operator) based on the reading(s) and the tariff(s). As another example, in the case of V2G, the server 180 credits the account of the electric vehicle operator based on the reading(s) and the tariff(s).

In embodiments where the tariff(s) are vehicle operator dependent tariff(s), in addition to determining the amount to bill the electric vehicle operator (or deduct from an account or other prepaid card or plan), the server 180 may also determine the amount that the electric utility would have billed if not for the vehicle operator dependent tariff(s). In one embodiment, the difference between the amounts is settled by the electric vehicle charging service (e.g., the entity that controls/operates the server 180). For example, the charging service keeps the difference if the amount billed by the utility is less than the amount billed to the electric vehicle operator and pays the difference if the amount billed by the utility is more than the amount billed to the electric vehicle operator.

While FIG. 4 illustrates the server 180 providing a time of use definition and/or tariff(s) to the charging station 120, in some embodiments the electric vehicle operator provides the time of use definition and/or tariff(s). By way of example, the electric vehicle operator 145 can use the mobile communication device 150 to communicate tariff(s) and/or different time periods for use in the time of use meter of the charging station 120. In some embodiments the tariff(s) and/or time of use definition is stored in encrypted form on the mobile communication device 150 and is decrypted by the charging station 120.

Thus unlike typical charging stations which do not include a time of use meter, embodiments of the invention allow for the charging stations to measure energy readings for multiple time periods. This allows for a greater granularity of billing for electricity since different tariffs can be charged for different times of the day (e.g., peak hours, non-peak hours, overnight hours, etc.). In addition, in some embodiments the time of use periods are specific to individual electric vehicle operators and apply to multiple charging stations that receive electric service from different electric utilities.

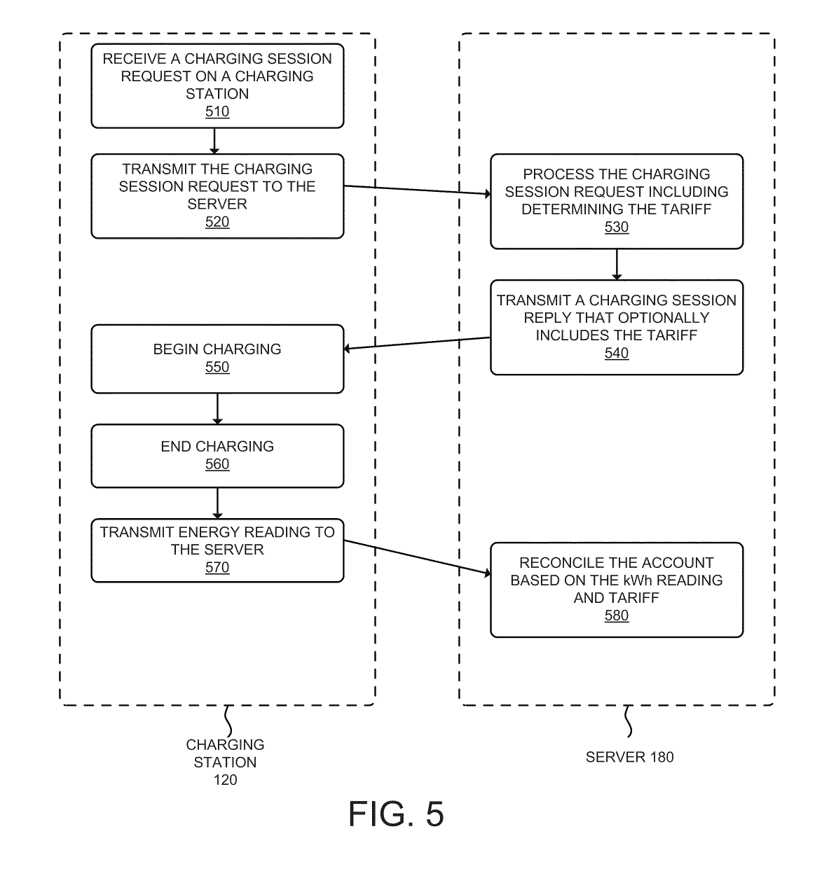

While FIG. 4 illustrates exemplary operations performed with a charging station that has a time of use meter, some charging stations do not include a time of use meter. For example, in these embodiments, the energy meter 220 of the charging station 120 is not a time of use meter. FIG. 5 is a flow diagram illustrating exemplary operations for a charging session on a charging station that does not have a time of use meter according to one embodiment of the invention. Similar to FIG. 4, FIG. 5 will be described with reference to the charging station 120 and the server 180; however it should be understood that other charging stations (e.g., the charging stations in the charging station groups 310, 320, and 330) can perform similar operations.

At block 510, a charging session request is received at the charging station 120 from the electric vehicle operator 145 in a similar way as the charging session request described in block 410 of FIG. 4. As described above, the charging session request may be received via the communication device 150, the payment station 160, and/or directly through the user interface 235. Control flows to block 520 where the charging station 120 transmits the charging session request to the server 180.

At block 530, the server 180 processes the charging session request including determining the tariff to apply for the charging session that is being requested. In one embodiment, the tariff is specific to the electric vehicle operator 145 (an electric vehicle operator dependent tariff), while in other embodiments the tariff is specific to different groups of vehicle operators (e.g., employees of a company, members of a travel group, etc.) or specific to the charging station 120, the electric utility 190, or the power grid 130.

The tariff selected can also depend on the time the request was received. For example, different tariffs can apply to different time periods (e.g., peak hours, non-peak hours, overnight hours, daytime hours, etc.). These different tariffs can also be specific to the electric vehicle operator 145, the charging station 120, the electric utility 190, the power grid 130, and/or different groups of vehicle operators (e.g., employees of a company, members of a travel group, etc.). As described above with reference to block 430 of FIG. 4, the server can also perform an authorization procedure to determine whether the electric vehicle operator is an authorized user.

With reference to FIG. 4, since the charging station 120 does not include a time of use meter, the server 180 does not determine the time of use periods which may be associated with the vehicle operator requesting the charging session. In a case where the vehicle operator requesting the charging session is associated with multiple tariffs for different time periods, the server 180 can select one of those tariffs to use and/or an average of the tariffs. In other embodiments, the electric vehicle operator is also associated with a different tariff for those charging stations that do not include a time of use meter.

Flow moves from block 530 to block 540 where the server 180 transmits a charging session reply which indicates the electric vehicle operator is authorized and also optionally includes the determined tariff for the charging session. According to one embodiment, the tariff is used by the charging station 120 to calculate the cost of the electricity consumed in cases where the request includes a monetary amount limit or a credit amount limit.

Flow moves from block 540 to block 550 where a charging session has been established and charging is allowed to commence as similarly described in reference to block 460 of FIG. 4. During the charging session, the charging station 120 measures the amount of current being consumed and uses that information to calculate the energy reading (e.g., kWh reading) for the charging session. In some embodiments, the charging station 120 also calculates the cost of the electricity being consumed based on the energy reading and the tariff received from the server 180.

Flow then moves to block 560 where the charging session has stopped. For example, the charging session has been terminated by the electric vehicle operator 145, the requested limit has been reached, etc. In some embodiments, a notification message (e.g., email, text message, etc.) is transmitted to the vehicle operator 145 that alerts the operator that the charging session has ended because a charging session duration limit (e.g., monetary, credit, etc.) has been met. Flow moves from block 560 to block 570, where the charging station 120 transmits the energy reading (e.g., kWh consumed during the charging session) to the server 180. The energy reading can be sent along with a charging session termination message that notifies the server 180 that the charging session has ended. Of course, it should be understood that the charging station 120 can transmit energy readings to the server 180 while the charging session is in progress.

Flow moves from block 570 to block 580, where the server 180 reconciles the account of the electric vehicle operator based on the reading and the tariff. For example, the server 180 bills the electric vehicle operator (or deducts from an account or prepaid card or plan of the electric vehicle operator) based on the energy reading and the tariff. In embodiments where the tariff is a vehicle operator dependent tariff, in addition to determining the amount to bill the electric vehicle operator (or deduct from an account or other prepaid card or plan), the server 180 also determines the amount that the electric utility would have billed the operator if not for the vehicle operator dependent tariff. In one embodiment, the difference between the amounts is settled by the electric vehicle charging service (e.g., the entity that controls/operates the server 180). For example, the charging service keeps the difference if the amount billed by the utility is less than the amount billed to the electric vehicle operator and pays the difference if the amount billed by the utility is more than the amount billed to the electric vehicle operator.

While FIG. 5 illustrates the server 180 providing a tariff to the charging station 120, in some embodiments the electric vehicle operator provides the tariff. By way of example, the electric vehicle operator 145 can use the mobile communication device 150 to communicate the tariff to the charging station 120. In some embodiments the tariff is stored in encrypted form on the mobile communication device 150 and is decrypted by the charging station 120.

Thus, unlike typical charging services where tariffs are location dependent and are set by the electric utilities, embodiments of the invention allow for electric vehicle operator dependent tariff(s) to be used. As described above, the electric vehicle operator dependent tariff(s) can apply to multiple charging stations that receive electrical service from different electric utilities. This provides a consistent experience for the vehicle operators in relation to the amount billed (or deducted) for charging service as the vehicles travel to different geographic locations serviced by different electric utilities.

While FIGS. 4 and 5 have been described in relation to the server 180 providing the time of use definition and/or tariff(s) to the charging station 120, in other embodiments the DCU 170 provides the time of use definition and/or the tariff(s) to the charging station 120. In addition, each individual charging station may be programmed with the time of use definitions and/or the tariff(s).

While the flow diagrams in the figures show a particular order of operations performed by certain embodiments of the invention, it should be understood that such order is exemplary (e.g., alternative embodiments may perform the operations in a different order, combine certain operations, overlap certain operations, etc.)

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A method for charging electric vehicles on an electric vehicle charging station having a time of use meter, the method comprising:
establishing a charging session between an electric vehicle and the electric vehicle charging station, wherein the electric vehicle is allowed to be charged during the established charging session; and
calculating energy readings for a plurality of time periods programmed into the time of use meter while the charging session is active, wherein the time of use meter measures energy in those time periods so that different tariffs can be applied to those time periods.

2. The method of claim 1, further comprising:
transmitting the calculated energy readings for the charging session to an electric vehicle charging station network server for accounting.

3. The method of claim 2, wherein establishing the charging session includes the following:
transmitting a message to the electric vehicle charging station network server requesting a charging session on behalf of an operator of the electric vehicle, wherein the message includes an identifier associated with the operator of the electric vehicle;
receiving a reply from the electric vehicle charging station network server indicating that the charging session is authorized; and
responsive to receiving the reply, allowing current to flow between the electric vehicle charging station and the electric vehicle.

4. The method of claim 3, further comprising:
receiving a time of use definition from the electric vehicle charging station network server based on the identifier associated with the operator of the electric vehicle, wherein the time of use definition indicates the time periods for the time of use meter; and
responsive to receiving the time of use definition, programming the time periods into the time of use meter.

5. The method of claim 3, further comprising:
receiving a plurality of tariffs corresponding to the plurality of time periods, wherein the plurality of tariffs are specific to the operator of the electric vehicle, wherein the electric vehicle charging station supplies electricity from a power grid operated by an electric utility, and wherein the plurality of tariffs are applicable for the operator on different electric vehicle charging stations that are supplied electricity from different electric utilities; and
terminating the charging session when a limit is reached, wherein the limit is based on the energy readings for each of the time periods and the tariffs of those time periods, and wherein the limit is one of a monetary amount and a credit amount in a credit based system.

6. The method of claim 3, wherein the plurality of tariffs are received from one of the electric vehicle charging station network server and the operator of the electric vehicle.

7. A method for charging electric vehicles on an electric vehicle charging station, wherein the electric vehicle charging station is supplied electricity from an electric utility, comprising:
establishing a charging session between an electric vehicle and the electric vehicle charging station, wherein the electric vehicle is allowed to be charged during the established charging session;
calculating one or more energy readings for the charging session that represent an amount of electricity consumed by the electric vehicle during the charging session;
transmitting the one or more energy readings to an electric vehicle charging station network server for accounting that is based on one or more tariffs specific to an operator of the electric vehicle, wherein the one or more tariffs specific to the operator of the electric vehicle are applicable to different electric vehicle charging stations that are supplied electricity from different electric utilities.

8. The method of claim 7, wherein establishing the charging session further includes:
receiving a request for the charging session from an operator of the electric vehicle;
transmitting the request to the electric vehicle charging station network server for authorization;
receiving a reply from the electric vehicle charging station network server indicating that the charging session is authorized; and
responsive to receiving the reply, allowing current to flow between the electric vehicle charging station and the electric vehicle.

9. The method of claim 8, further comprising:
receiving the one or more tariffs specific to the operator of the electric vehicle from one of the electric vehicle charging station network server and the operator of the electric vehicle; and
terminating the charging session when a limit is reached, wherein the limit is based on the one or more energy readings and the one or more tariffs, and wherein the limit is one of a monetary amount and a credit amount in a credit based system.

10. The method of claim 9, wherein there is at least two tariffs specific to the operator of the electric vehicle, and wherein there are at least two energy readings for the charging session based on measurements from at least two time periods in a time of use meter on the electric vehicle charging station.

11. The method of claim 10, wherein the at least two time periods are received from the electric vehicle charging station network server.

12. An electric vehicle charging station for charging electric vehicles, comprising:
a charging point connection to couple electric vehicles to a power line coupled with a power grid that is operated by an electric utility;
a programmable time of use meter to provide metering for a plurality of different time periods,
a transceiver to communicate with an electric vehicle charging station network server; and
one or more control modules coupled with the programmable time of use meter and the transceiver, the one or more control modules to perform the following:
program the programmable time of use meter with a plurality of time periods;
cause the charging point connection to be energized to allow current to flow through the charging point connection; and
calculate energy readings for the time periods.

13. The electric vehicle charging station of claim 12, wherein the one or more control modules also cause the energy readings to be transmitted to the electric vehicle charging station network server for accounting.

14. The electric vehicle charging station of claim 13, wherein the plurality of time periods are specific to individual operators of electric vehicles, and wherein the plurality of time periods are to be received from the electric vehicle charging station network server.

15. The electric vehicle charging station of claim 13, wherein a plurality of tariffs for the plurality of time periods are to be received from the electric vehicle charging station network server, and wherein at least some of the plurality of tariffs are specific to individual operators of electric vehicles and are applicable to different electric vehicle charging stations that are supplied with electricity by different electric utilities, and wherein the one or more control modules are also cause the charging point connection to be de-energized based on a limit of the charging sessions being reached based on appropriate ones of the energy readings and tariffs of those time periods.

16. An electric vehicle charging system, comprising:
a plurality of electric vehicle charging stations that charge electric vehicles, wherein different ones of the plurality of electric vehicle charging stations are supplied electricity from different electric utilities, wherein each electric vehicle charging station performs the following:
calculates energy readings for charging sessions, and
transmits the calculated energy readings to an electric vehicle charging station network server; and
the electric vehicle charging station network server coupled with each of the plurality of electric vehicle charging stations, wherein the electric vehicle charging station network server performs accounting including applying appropriate electric vehicle operator specific tariffs to received energy readings; and
wherein each electric vehicle operator specific tariff is specific to a vehicle operator and applies to each of the plurality of electric vehicle charging stations regardless of which of the electric utilities supplies the electricity to that electric vehicle charging station.

17. The electric vehicle charging system of claim 16, wherein at least some of the plurality of electric vehicle charging stations further include a time of use meter to provide metering for a plurality of different time periods, wherein the electric vehicle charging station network server provides the different time periods to those electric vehicle charging stations.

18. The electric vehicle charging system of claim 17, wherein the different time periods are specific to individual electric vehicle operators.

19. The electric vehicle charging system of claim 17, wherein the electric vehicle charging station network server is also to provide appropriate electric vehicle operator specific rates to the electric vehicle charging stations, wherein the electric vehicle charging stations terminate charging sessions based on reaching a limit for the charging session, wherein the limit is based on the energy readings and the electric vehicle operator specific rates.
